(19) United States
(12) Patent Application Publication
(10) Pub. No.: US 2025/0362188 A1
(43) Pub. Date: Nov. 27, 2025

(54) SYSTEMS AND METHODS FOR AN EMBEDDED SENSOR

(71) Applicant: PURDUE RESEARCH FOUNDATION, West Lafayette, IN (US)

(72) Inventor: Muhammad Mustafa Hussain, West Lafayette, IN (US)

(21) Appl. No.: 19/215,136

(22) Filed: May 21, 2025

Related U.S. Application Data
(60) Provisional application No. 63/651,125, filed on May 23, 2024.

(51) Int. Cl. G01L 1/14; G01L 1/26; G01L 5/101

(52) U.S. Cl. CPC G01L 1/146; G01L 1/26; G01L 5/101

(57) ABSTRACT

An embedded sensor system and method for sensing stress on a structure is provided. The embedded sensor system may include a filament embedded within a structure, a plurality of sensors spaced apart along the filament and in electronic communication with the filament, and a controller including an electronic processor. The controller provides current, via the filament, to the plurality of sensors; receives an electronic signal from the plurality of sensors via the filament; determines a stress on the structure based on the electronic signal; and indicates the stress on the structure.

### RELATED APPLICATIONS

This application claims priority to U.S. Provisional Application No. 63/651,125, filed on May 23, 2024, titled “SYSTEMS AND METHODS FOR AN EMBEDDED SENSOR,” which is hereby incorporated by reference in its entirety.

### TECHNICAL FIELD

This disclosure relates to the field of a sensor system. More particularly, this disclosure relates to systems and methods for an embedded sensor system, for example, within a structural material.

### SUMMARY

A structural material such as, for example, a beam, a column, or a shaft can fail in a brittle or ductile manner under stress. For example, the structural material can fracture due to static overload or buckle due to compressive overload. Monitoring structural health (e.g., stress, cracks, deflections, deformations, etc.) can enable detection of structural issues before a material failure occurs. Monitoring structural health with sensors installed on an exterior of the structural material can leave the sensors vulnerable to external environment-induced impacts, wear and tear, and corrosion, which can cause the sensors to become unreliable to monitor the structural health.

These and other problems may be overcome by systems, methods, and devices having configurations as set forth herein. Thus, the present disclosure provides for sensor systems embedded within a structure, for example, to monitor stress on the structure.

According to one aspect of the present disclosure, an embedded sensor system is provided. The embedded sensor system includes a filament embedded within a structure, a plurality of sensors spaced apart along the filament and in electronic communication with the filament, and a controller including an electronic processor. The controller is configured to provide current, via a filament, to the plurality of sensors, receive an electronic signal from the plurality of sensors via the filament, determine a stress on the structure based on the electronic signal, and indicate the stress on the structure.

According to another aspect of the present disclosure, a method for monitoring stress on a structure is provided. The method includes providing current, via a filament embedded within a structure, to a plurality of sensors embedded in the structure and spaced apart along the filament. By a controller, an electronic signal is received form the plurality of sensors via the filament. A stress is determined on the structure based on the electronic signal and indicated on the structure.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be understood that the drawings are not to scale unless otherwise indicated.

FIG. 1A illustrates an example of an embedded sensor system in accordance with various aspects of the present disclosure.

FIG. 1B illustrates an example of an embedded sensor system in accordance with various aspects of the present disclosure.

FIG. 2 illustrates an example of an embedded sensor system in accordance with various aspects of the present disclosure.

FIG. 3 illustrates an example of a sensor sub-system in accordance with various aspects of the present disclosure.

FIG. 4 illustrates an example of a sensor sub-system in accordance with various aspects of the present disclosure.

FIG. 5 illustrates an example of a sensor sub-system in accordance with various aspects of the present disclosure.

FIG. 6 is a flowchart that illustrates an example of monitoring stress on a structure in accordance with various aspects of the present disclosure.

FIG. 7A illustrates an example of a sensor sub-system in accordance with various aspects of the present disclosure.

FIG. 7B illustrates an example of a sensor sub-system in accordance with various aspects of the present disclosure.

FIG. 7C illustrates an example of characteristics for sensor sub-systems of FIGS. 7A and 7B in accordance with various aspects of the present disclosure.

FIG. 7D illustrates an example of characteristics for sensor sub-systems of FIGS. 7A and 7B in accordance with various aspects of the present disclosure.

FIG. 7E illustrates the sensor sub-system of FIG. 7B in a first elongated configuration.

FIG. 7F illustrates the sensor sub-system of FIG. 7B in a second elongated configuration.

FIG. 7G illustrates the sensor sub-system of FIG. 7B in a third elongated configuration.

FIG. 7H illustrates the sensor sub-system of FIG. 7B in a fourth elongated configuration.

FIG. 8A illustrates an example of a sensor sub-system in accordance with various aspects of the present disclosure.

FIG. 8B illustrates an example of a plurality of the sensor sub-systems of FIG. 8A in accordance with various aspects of the present disclosure.

FIG. 8C illustrates an example of a plurality of the sensor sub-systems of FIG. 8A in accordance with various aspects of the present disclosure.

FIG. 8D illustrates an example of a plurality of the sensor sub-systems of FIG. 8A in accordance with various aspects of the present disclosure.

FIG. 8E illustrates an example of characteristic for the pluralities of sensor sub-systems of FIGS. 8B-8D in accordance with various aspects of the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration. Moreover, discussion of “horizontal” or “vertical” features may in some implementations be relative to the earth's surface; however, in other implementations, a “horizontal” feature is not necessarily parallel to the earth's surface. Thus, more generally “horizontal” or “longitudinal” may refer to the extending direction of a structural material (e.g., a beam), whereas “vertical” or “radial” may refer to a direction perpendicular to horizontal. Additionally, unless otherwise limited or defined, the terms “about” and “approximately” refers to a range of within 1%, 2%, or 5% of a particular value in the units provided (e.g., approximately 100 meters may refer to 99-101 meters, 98-102 meters, or 95-105 meters).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

As noted above, it can be challenging to monitor health (e.g., stress, cracks, deflections, deformations, etc.) of a structural material with a sensor system that is mounted on an external surface of a structure or a structural element. In some cases, the sensor system can be bulky, heavy, or hard to maintain. Thus, the present disclosure provides for an improved sensor system that is embedded in the structure (e.g., a beam). The systems, methods, and devices according to the present disclosure provides several advantages associated with embedding the sensor system within the structural material itself, including but not limited to improved protection from external environment impacts, area preservation, weight reduction, improved energy efficiency, lower manufacturing or maintenance cost, improved data management, and/or optimized material selection.

In one example, the present disclosure sets forth a sensor system that can be embedded within a structure. The sensor system can include sensor sub-systems that are spaced apart along a length of the structure. When the structure is under a particular amount of stress or a stress over a period of time, the structure can experience mechanical deformation. When such deformation occurs, the sensor system can send a signal indicative of a status of the structure (e.g., indicative of a level of stress or load). Stress or load on a structure may refer to strain on the structure and compression on the structure.

In particular, the sensor system can include sensor nodes that are spaced apart along a conductive filament. The filament can be ultra-thin but mechanically resilient to respond to a variety of stress and thermal conditions. The filament may be implemented in various forms including electrically conductive filaments, optical filaments (e.g., fiber Bragg gratings) for light-based sensing, hydrogel-encapsulated filaments for providing protection in wet environments, or multifilament braids for providing redundancy or enabling multi-mode (e.g., dual-mode) sensing capabilities via incorporating multiple types of sensors. In some embodiments, the sensor system with a light-based sensing capability and optical filaments(s) can include an optical sensor for monitoring polarization of light, which can be changed based on a status (e.g., stress or load) of the structure. For example, as light is being transmitted by an optical filament to and through the optical sensor(s) along the filament, the optical sensor(s) may vary the polarization of the light in a manner proportional or responsive to the status of (e.g., stress or load on) the structure. Further, based on types or combinations of loads (e.g., tensile, compressive, shear loads) and magnitude of the loads, a condition of the filament or sensor(s) along the filament may change, and, in response, the sensor system can send electronic signals to indicate the change and, thereby, a status of the structure.

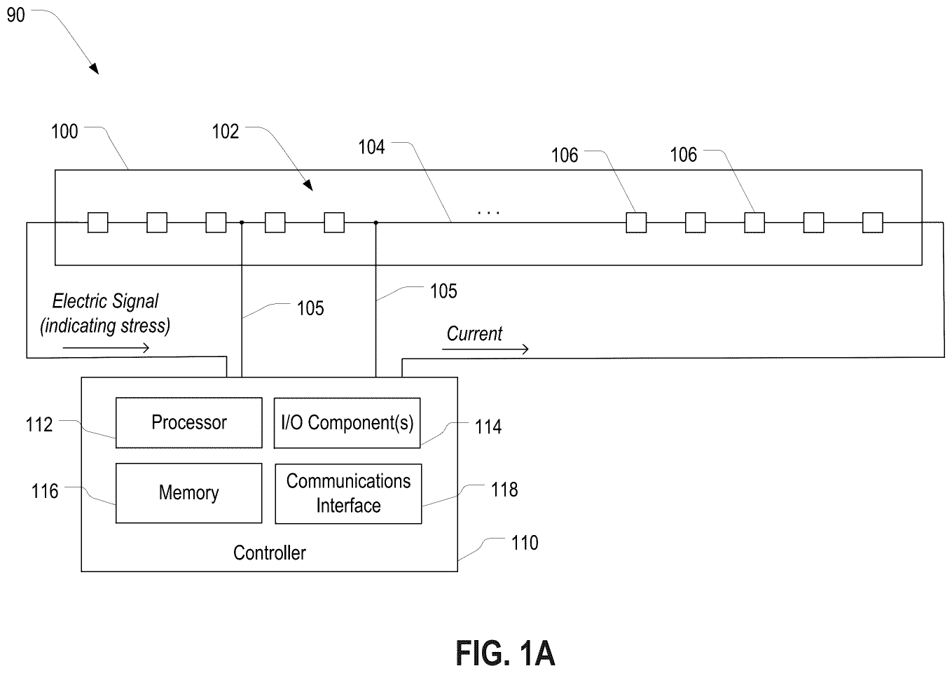

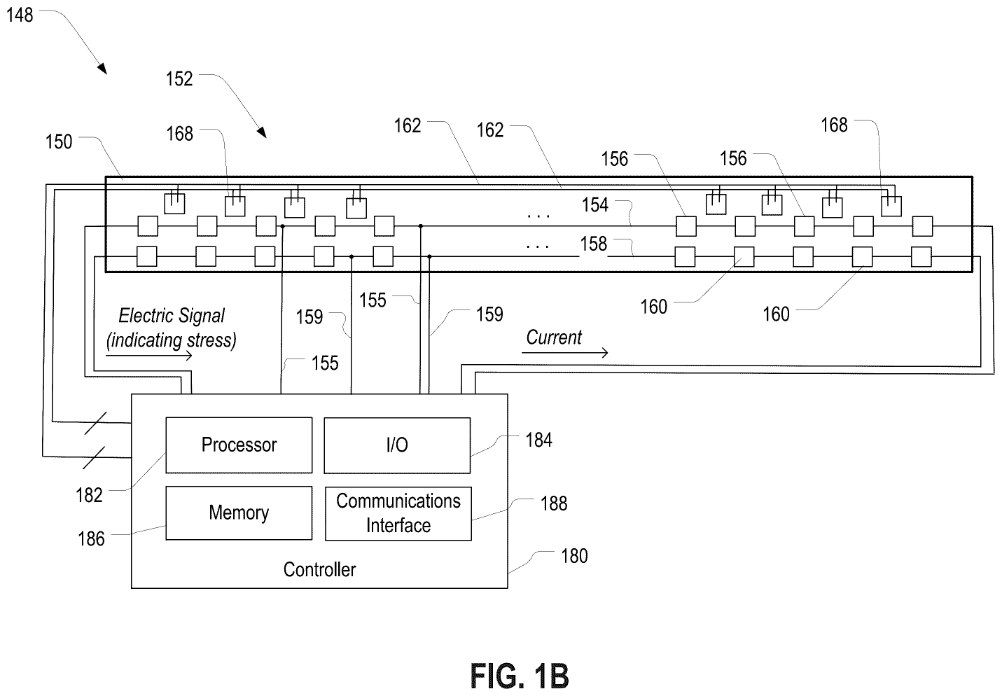

FIG. 1A illustrates an example structure sensing system 90 including a sensor system 102 (e.g., a sensor network) and a controller 110. The sensor system 102 can be embedded within a structure 100 (e.g., a structural element). The structure 100 can be a cylindrical rod and include a hollow volume that is shaped and sized to receive the sensor system 102. Alternatively or additionally, the structure 100 can be manufactured to integrally secure the sensor system 102 within the structure 100 (e.g., during an additive manufacturing process). In the present example, the structure is stainless steel beam. However, alternative materials can be used, including carbon steel, alloy steel, rebar steel, weathering steel, structural steel, light gauge steel, timber, glulam, or concrete for various applications such as a missile system, a hypersonic system, a rocket, a nuclear reactor, or a submarine body.

Continuing, the sensor system 102 can include a filament 104 and a plurality of sensors 106 spaced apart along the filament 104. The plurality of sensors 106 can be evenly or irregularly distributed throughout the filament 104 or in a specific pattern. The filament 104 may include filament segments, and the plurality of sensors 106 can be connected in series along the filament 104, with a filament segment of the filament segments between adjacent sensors of the plurality of sensors 106. In some embodiments, placement of the plurality of sensors 106 may be related to specific locations on the structure 100. The plurality of sensors 106 can include a flexible substrate and can be flexibly integrated into the structure 100. Further, the plurality of sensors 106 can be in electronic communication with the filament 104 that may be conductive. Correspondingly, the filament 104 can transmit electric current throughout or deliver an electric signal to indicate stress on the structure 100 to other systems.

A controller 110 can be provided to interact with various components of the sensor system 102 to perform various tasks, for example, in response to control signals provided by an operator or one or more of the plurality of sensors 106 of the sensor system 102. In particular, the controller 110 may be in an electronic communication with the sensor system 102. As illustrated, the controller 110 may be connected to each end of the filament 104 at respective connection points of the controller 110. The controller 110 can deliver current to the filament 104 or receive an electric signal from the filament 104 (e.g., to determine variables including capacitance, conductance, temperature, humidity of the structure 100). In some embodiments, the controller 110 can receive the electric signal(s) from one or more filament branches 105 of the filament 104. For example, the filament branches 105 can be positioned between one or more of the plurality of sensors 106 along the filament 104 and individually connected to the controller 110 at respective connection points of the controller 110. Thus, the filament branches 105 can permit access to multiple points along the filament 104, thereby allowing identification of a status of the structure 100 (e.g., with increased precision or accuracy) due to varying of the electrical signal(s) from the one or more of the plurality of sensors 106. Although only two filament branches 105 are illustrated, additional filament branches 105 are included in some examples. For example, a filament branch 105 may be provided at or between each sensor 106, at or between every other sensor 106, or at another quantity and position.

In the present embodiment, the controller 110 can include a processor 112, one or more Input/Output (I/O) components 114, a memory 116, and a communications interface 118. Those skilled in the art will appreciate that there may be additional infrastructure in the controller 110 that is not shown in FIG. 1A.

In some embodiments, processor 112 can be any suitable hardware processor or combination of processors, such as a microcontroller, a central processing unit (CPU), an accelerated processing unit (APU), a graphics processing unit (GPU), a field programmable gate array (FPGA), an application specific integrated circuit (ASIC), etc.

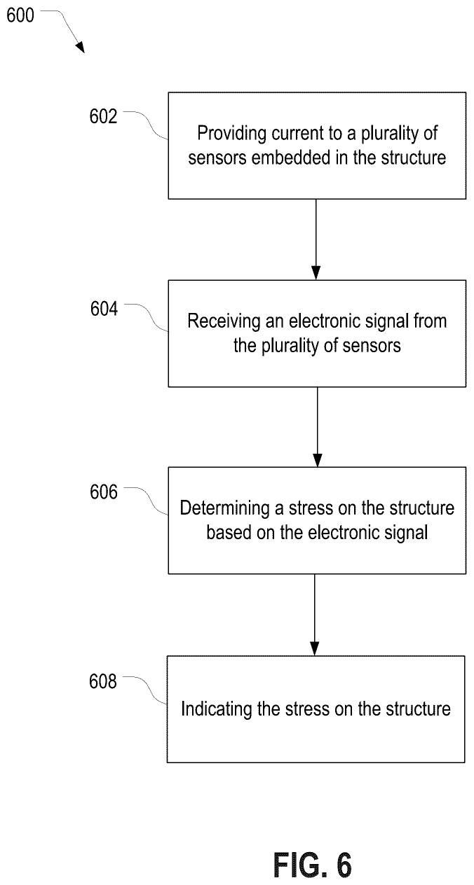

In some embodiments, memory 116 may be a non-transitory processor readable or computer readable storage medium. Memory 116 may comprise read-only memory (“ROM”), random access memory (“RAM”), other non-transitory computer-readable media, or a combination thereof. Memory 116 may be any electronic, magnetic, optical, or other physical storage device that stores executable instructions and/or data. Memory 116 may store filters, rules, data, or a combination thereof. The memory 116 may store sensor data obtained from the sensor system 102 and processed by the processor 112. In some examples, the memory 116 may store a histogram of the sensor data for a health monitoring (e.g., a pattern recognition) of the structure 100. The memory 116 may also store computer readable instructions (e.g., program code) that the processor 112 is configured to retrieve and execute to perform functionality of the processor 112 and the controller 110 described herein. For example, the memory 116 may store computer readable instructions (e.g., program code) that, when executed, cause the processor 112 (and, thus, the controller 110) to perform the process 600 of FIG. 6 and variations thereof described herein.

The I/O component(s) 114 may include any apparatus that permits a person to interact with the sensor system 102. The apparatus may include a keyboard, a touchscreen, and/or a display (e.g., displaying a graphical user interface (GUI) generated by the processor 112). The apparatus may include a voice user interface (VUI) that enables interaction with the controller 110 through voice commands. The apparatus may comprise mechanical switches, buttons, and knobs. The I/O 114 component(s) may include any other apparatus, circuitry and/or component that permits the person to interact with the sensor system 102. In some embodiments, a display of the I/O component(s) 114 can display information related to health of the structure 100.

In some embodiments, communications interface 118 can include any suitable hardware, firmware, and/or software for communicating information over any suitable communication networks. For example, communications interface 118 can include one or more transceivers, one or more communication chips and/or chip sets, etc. In a more particular example, communications interface 118 can include hardware, firmware and/or software that can be used by the controller 110 to establish a Bluetooth connection, Wi-Fi connection, a cellular connection, a universal service bus (USB) connection, an Ethernet connection, etc. with another device. In some embodiments, the processor may transmit or output information related to health of the structure 100 via the communications interface 118 to an external computing device (e.g., a server, personal computer, mobile phone, tablet, etc.) via a network.

FIG. 1B illustrates an example structure sensing system 148 including an example sensor system 152 and a controller 180. Similar to the sensor system 102 described above, the sensor system 152 can include similar components and functions to the sensor system 102. Thus, like names to designate the same or similar components described above will be used where applicable. In some aspects, however, the sensor system 152 and the sensor system 102 differ. For example, the sensor system 152 includes multiple sensor systems as will be discussed in detail below.

In particular, the sensor system 152 includes a first filament 154 embedded within a structure 150 and a first plurality of sensors 156 spaced apart along the first filament 154. The first filament 154 may include filament segments, and the first plurality of sensors 156 can be connected in series along the first filament 154, with a filament segment of the filament segments between adjacent sensors of the first plurality of sensors 156. The first filament 154 can include first filament branches 155 positioned between one or more of the first plurality of sensors 156. The first filament 154 and the first plurality of sensors 156 may extend along a first axis (not separately illustrated but colinear with the first filament 154). Further, the sensor system 152 includes second filament 158 embedded within a structure 150 and a second plurality of sensors 160 spaced apart along the second filament 158 and in electronic communication with the second filament 158. The second filament 158 may include filament segments, and the second plurality of sensors 160 can be connected in series along the second filament 158, with a filament segment of the filament segments between adjacent sensors of the second plurality of sensors 160. The second filament 158 can include second filament branches 159 positioned between one or more of the second plurality of sensors 160. The second filament 158 and the second plurality of sensors 160 may extend along a second axis (not separately illustrated but colinear with the second filament 158) that is different than the first axis. The second axis and the first axis may be substantially parallel to one another (e.g., within +/−2, 5, or 10 degrees of parallel). The first plurality of sensors 156 and the second plurality of sensors 160 may include respective flexible substrates (e.g., soft polymer or flexible glass). For example, a first flexible substrate may have the plurality of sensors 156 thereon and a second flexible substrate may have the plurality of sensors 160 thereon. Additionally, in some examples, additional flexible substrates may be provided such that subsets of the first plurality of sensors 156 are each positioned on a respective flexible substrates, and subsets of the second plurality of sensors 160 are each positioned on further respective substrates. In some embodiments, the first plurality of sensors 156 and the second plurality of sensors 160 may be made with rigid substrates.

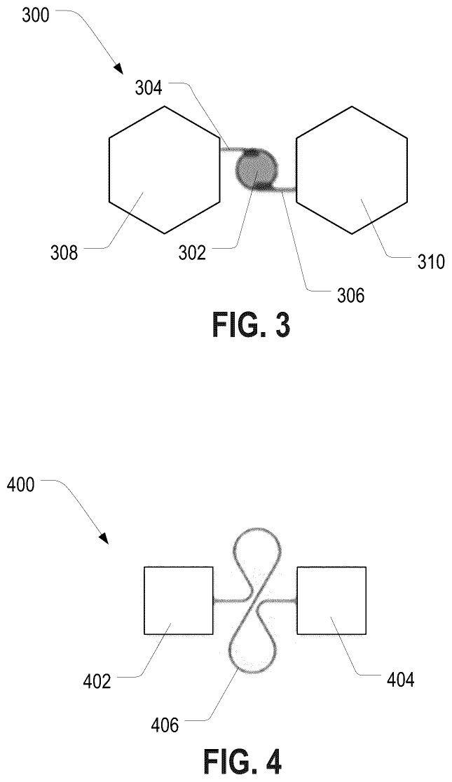

In the illustrated example, the first plurality of sensors 156 and the second plurality of sensors 160 are both fractal-based sensors that are designed or configured to detect discontinuity in the corresponding first filament 154 or the second filament 158. However, in some embodiments, the second plurality of sensors 160 may be a different sensor type than the first plurality of sensors 156. For example, the second plurality of sensors 160 can include sensors that are a spiral type, and the first plurality of sensors 156 can include sensors that are a serpentine type. The first plurality of sensors 156 may have a different sensitivity to stress than the second plurality of sensors 160, a different fracture point than the second plurality of sensors 160, a different prescribed displacement than the second plurality of sensors 160, a different maximum stretchability than the second plurality of sensors 160, or a different uncertainty (e.g., at different stress levels or surrounding conditions) than the second plurality of sensors 160. Thus, the first plurality of sensors 156 and the second plurality of sensors 160 may respond to various loads differently or withstand different magnitudes of stress or strain until fracture. As described further below, FIGS. 3 and 4 illustrates a spiral type sensor and a serpentine type sensor, respectively.

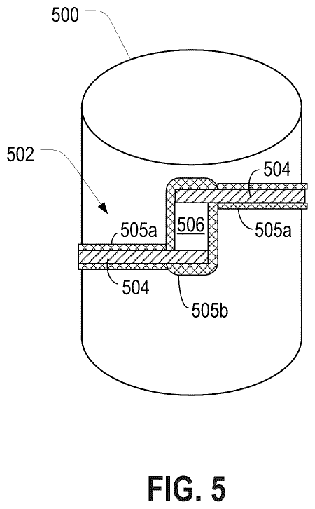

In some embodiments, the sensor system 152 can include a third plurality of sensors 168 that are embedded within the structure 150. The third plurality of sensors 168 may be different than the first and second plurality of sensors 156, 160. In particular, the third plurality of sensors 168 can be capacitive sensors with independent connections to separate filaments (e.g., a respective filament for each of two plates of the capacitive sensor). The third plurality of sensors 168 can be spaced apart in the structure 150. The third plurality of sensors 168 and a plurality of conductors 162 can extend along a third axis (not separately illustrated) that is different than the first and second axes. The third axis may be substantially parallel to the first or second axes. Each sensor of the third plurality of sensors 168 may be connected by a respective pair of filaments of the plurality of conductors 162 to the controller 180. Accordingly, each sensor of third plurality of sensors 168 may be connected independently to the controller 180. An example of a sensor of the third plurality of sensors 168 is illustrated and described with respect to FIG. 5.

A controller 180 can be provided to interact with various components of the sensor system 152 to perform various tasks, for example, in response to control signals provided by an operator or one or more of the first plurality of sensors 156, the second plurality of sensors 160, or the third plurality of sensors 168. In particular, the controller 180 may be in an electronic communication with the sensor system 152. As illustrated, the controller 180 may be connected to each end of the first filament 154 and/or the second filament 158 at respective connection points of the controller 180. In some embodiments, the controller 180 can deliver current to the first filament 154 and/or the second filament 158. The controller 180 can receive electric signals from the first filament 154, the first filament branches 155, the second filament 158, and/or the second filament branches 159 (e.g., at respective connection points of the controller 180). Thus, the controller 180 can identify a status of the structure 150 from multiple access points along the first filament 154 and the second filament 158 more effectively (e.g., with increased precision or accuracy) due to varying electrical signal from the one or more of the plurality of sensors 156 or 160. Although only two filament branches 155 and two filament branches 159 are illustrated, additional filament branches 155 or 159 are included in some examples. For example, a filament branch may be provided at or between each sensor, at or between every other sensor, or at another quantity and position.

Further, the controller 180 can include a processor 182, an Input/Output (I/O) 184, a memory 186, and a communications interface 188. Aside from the additional functionality related to interacting with multiple pluralities and types of sensors, the controller 180 and the components thereof may be generally similar to the controller 110. Accordingly, the discussion of components 112, 114, 116, 118 provided above similarly applies to the components 182, 184, 186, and 188, respectively, unless otherwise indicated. Additionally, as an example, the memory 186 may be a non-transitory computer readable medium that stores computer readable instructions (e.g., program code) that, when executed, cause the processor 182 (and, thus, the controller 180) to perform the process 600 of FIG. 6 and variations thereof described herein. Those skilled in the art will appreciate that there may be additional infrastructure in the controller 180 that is not shown in FIG. 1B. For example, additional filaments and corresponding sensors along the filaments may be provided. Each set of sensors may be of a similar or different type than the first and second plurality of sensors 156, 160. Additionally, in some examples, the sensor system 152 does not include one or more of the first plurality of sensors 156, the second plurality of sensors 160, or the third plurality of sensors 168.

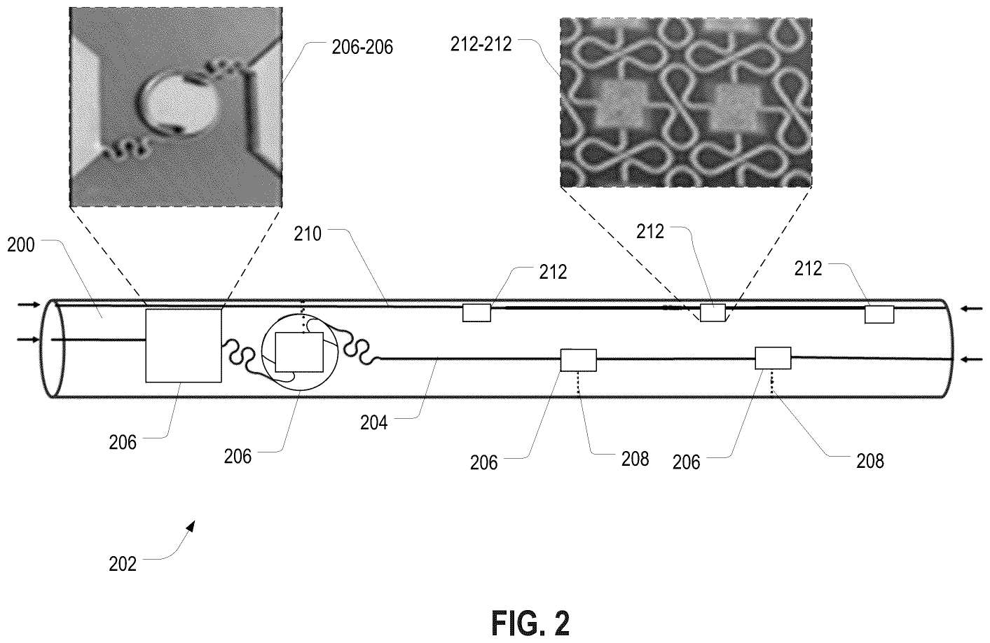

FIG. 2 illustrates an example sensor system 202. Similar to the sensor systems 102, 152 described above, the sensor system 202 can include similar components and functions to the sensor systems 102, 152. Thus, like names to designate the same or similar components described above will be used where applicable. In some aspects, however, the sensor systems 102, 152, 202 differ. For example, the sensor system 202 includes two sets of sensors, each of a specified type (whereas FIGS. 1A and 1B illustrate the sensors generally). For example, the sensor system 202 includes a first plurality of sensors 206 having a spiral-based interconnect and a second plurality of sensors 212 having a serpentine-based (e.g., horseshoe-shaped) interconnect. An area labeled “206-206” illustrates an enlarged view of an example of the first plurality of sensors 206. An area labeled “212-212” illustrates an enlarged view of an example of the second plurality of sensors 212. Accordingly, the sensor system 202 may be a particular example of the sensor system 152 of FIG. 1B, although an embodiment of the sensor system 152 in which the third plurality of sensors 168 is not included. Additionally, the discussion of the filaments and sensors of the sensor system 202 applies to at least some examples of filaments and sensors of the sensors systems 102, 152. Additionally, although a controller is not illustrated in FIG. 2, in some examples, a controller similar to the controller 110 or 180 is provided to interact with the sensor system 202.

In particular, the sensor system 202 is embedded within a structure 200. The first plurality of sensors 206 can be spaced apart along a first filament 204 that may be conductive. The second plurality of sensors 212 can be spaced apart along a second filament 210 that may be conductive. The first filament 204 and the second filament 210 may be placed in parallel or substantially in parallel to each other (e.g., without direct physical contact). The first filament 204 may include filament segments, and the first plurality of sensors 206 can be connected in series along the first filament 204, with a filament segment of the filament segments between adjacent sensors of the first plurality of sensors 206. The second filament 210 may include filament segments, and the second plurality of sensors 212 can be connected in series along the second filament 210, with a filament segment of the filament segments between adjacent sensors of the second plurality of sensors 212.

The first plurality of sensors 206 and the second plurality of sensors 212 can monitor a status of the structure 200 at various locations of the structure. Further, the first plurality of sensors 206 can receive signals about sidewalls of the structure 200 from pilot connectors 208, also referred to as filament branches 208. Additionally or alternatively, the pilot connectors 208 can be in communication with a controller (not shown) to signal status of the structure 200 at intermediate positions between the first plurality of sensors 206. In some examples, additional filament branches 208 are provided for the filament 204, and/or are filament branches are provided for the filament 210.

In some embodiments, the first plurality of sensors 206 and the second plurality of sensors 212 have different characteristics, including a stress that causes fracture and a prescribed displacement. Thus, when the structure 200 is under longitudinal tensile stress, the first plurality of sensors 206 and the second plurality of sensors 212 may exhibit different resistive and capacitive values and may fail (fracture) under different magnitudes of load. Further, when the structure 200 is under compressive stress, the first plurality of sensors 206 and the second plurality of sensors 212 may exhibit different resistive and capacitive values.

In some embodiments, the sensors of the sensor systems described herein (e.g., the sensors 106, 156, 160, 206, and/or 212) can include three-dimensional integrated circuits (3D-ICs). Such 3D-IC implementation can reduce circuit area compared to monolithic laterally dispersed integrated circuits. For example, instead of using lateral interconnects, a 3D-IC configuration allows non-planar vertical interconnects to enable shorter distancing between components. The shorter distances can result in faster data transmission and power savings. The 3D-ICs may also be thinned down for forming through polymer vias (TPVs) (for vertical interconnects), resulting in weight reductions. Also, instead of a rigid printed circuit board (PCB), the 3D-ICs may use polymeric host substrates and polymeric encapsulation, compared to traditional rigid encapsulation. These features may also result in weight reduction.

FIG. 3 illustrates a first sensor sub-system 300, also referred to as a spiral type sensor 300. The spiral type sensor 300 is an example of a sensor of the plurality of sensors 106 (FIG. 1A), 156 (FIG. 1B), 160 (FIGS. 1B), and 206 (FIG. 2). The first sensor sub-system 300 can include a sensor 302 (e.g., a connector) having one end connected by a first spiral interconnect 304 to a first conductive plate 308 and an opposite end connected by a second spiral interconnect 306 to a second conductive plate 310. The first spiral interconnect 304 or the second spiral interconnect 306 can be formed with conductive material such as copper, aluminum, and graphene. Although illustrated as generally straight, in some examples, the first and/or second spiral interconnect 304, 306 have a plurality of curved portions (e.g., similar to the serpentine interconnect 406). The first sensor sub-system 300 can have a first capacitance when the first sensor sub-system 300 is in an extended configuration (e.g., when the plates 308 and 310 move away from one another). The first sensor sub-system 300 can have a second capacitance when the first sensor sub-system 300 is in a retracted configuration (e.g., when the plates 308 and 310 move closer to one another).

The below table illustrates various mechanical responses based on material types of the sensor 302, first spiral interconnect 304, or the second spiral interconnect 306. In particular, for a constant thickness of the first spiral interconnect 304 or the second spiral interconnect 306 (e.g., 5 μm), prescribed displacement, maximum stretchability, intrinsic fracture stain, and stress at fracture are shown.

| | Prescribed | Maximum | Intrinsic | Stress at |
|---|---|---|---|---|
| | Displacement | Stretchability | Fracture | Fracture |
| Material | (mm) | (%) | Strain (%) | (GPa) |
| Silicon | 1.612 | 154 | 1 | 1.69 |
| Silver | 1.726 | 164.44 | 2 | 0.104 |
| Gold | 2.0 | 190 | 5 | 0.401 |
| Copper | 1.8702 | 178.11 | 5 | 0.622 |
| Aluminum | 2.124 | 202.28 | 20 | 0.298 |
| Graphene | 2.244 | 213.71 | 22 | 202 |

FIG. 4 illustrates a second sensor sub-system 400, also referred to as a serpentine type sensor 400. The serpentine type sensor 400 is an example of a sensor of the plurality of sensors 106 (FIG. 1A), 156 (FIG. 1B), 160 (FIGS. 1B), and 212 (FIG. 2). The second sensor sub-system 400 can include a first sub-sensor 402 connected by a serpentine interconnect 406 to a second sub-sensor 404. The serpentine interconnect 406 can include a plurality of curved portions. For example, the curved portions may form a serpentine or winding path of repeated turns or bends. The second sensor sub-system 400 can have a first capacitance when the serpentine interconnect 406 is in an extended configuration (e.g., when the sub-sensors 402 and 404 move away from one another). The second sensor sub-system 400 can have a second capacitance when the serpentine interconnect 406 is in a retracted configuration (e.g., when the sub-sensors 402 and 404 move closer to one another). The second capacitance can be greater than the first capacitance. Generally, the serpentine interconnect 406 becomes straighter, with reduced total curvature, the further that the sub-sensors 402 and 404 move away from one another.

The below table illustrates various mechanical responses based on material types of the first sub-sensor 402, the second sub-sensor 404, or the serpentine interconnect 406. In particular, for a constant thickness of the serpentine interconnect 406 (e.g., 5 μm), prescribed displacement, maximum stretchability, intrinsic fracture stain, and stress at fracture are shown.

| | Prescribed | Maximum | Intrinsic | Stress at |
|---|---|---|---|---|
| | Displacement | Stretchability | Fracture | Fracture |
| Material | (mm) | (%) | Strain (%) | (GPa) |
| Silicon | 6.98 | 410.59 | 1 | 1.70 |
| Silver | 6.98 | 410.59 | 2 | 0.089 |
| Gold | 6.99 | 411.17 | 5 | 0.22 |
| Copper | 7.0 | 411.76 | 5 | 0.24 |
| Aluminum | 7.0 | 411.76 | 20 | 0.17 |
| Graphene | 8.346 | 490.94 | 22 | 153 |

FIG. 5 illustrates a third sensor sub-system 502, also referred to as a capacitive type sensor, that can be embedded within a structure 500 along a traverse direction or a longitudinal direction. In particular, the third sensor sub-system 502 can include two conductive elements or plates 504 that extend transversely relative to the structure 500 and that are spaced apart from one another. The third sensor sub-system 502 can be a capacitive sensor (e.g., piezoelectric). The third sensor sub-system 502 is an example of a sensor of the third plurality of sensors 168 (FIG. 1B). The two conductive elements 504 can have a capacitance that varies based on an amount of stress on the structure 500.

The two conductive elements 504 are spaced apart from one another, forming a cavity 506 (e.g., an air gap). The conductive elements 504 and the cavity 506 may be covered by an electrically insulating material. For example, a first portion of each of the conductive elements 504 may be covered or encapsulated by a first electrical insulator 505a. Additionally, a second portion of each of the conductive elements 504 and the cavity 506 may be covered or encapsulated by a second electrical insulator 505b. Stress on the structure 500, whether strain or compression, can change a distance between the two conductive elements 504, thereby changing the capacitance of the third sensor sub-system 502. For example, when the structure 500 is under compressive stress, the capacitance in the cavity 506 may increase. On the contrary, the capacitance in the cavity 506 may decrease when the structure 500 is under longitudinal tensile stress. Therefore, the two conductive plates 504 can permit determining the condition of the structure 500 based on a change in capacitance values. While the illustrated example shows the two conductive elements 504 extending transversely relative to the structure 500, other examples can include two conductive elements 504 extending longitudinally relative to the structure 500. Further, the third sensor sub-system 502 can include a greater number of conductive plates, including three, four, five, etc.

FIG. 6 is a flowchart illustrating a process 600 for monitoring of a structure using an embedded sensor system such as the sensor systems 102, 152, 202, although other types of sensor systems can be used. Although the flowchart illustrates blocks sequentially and in a particular order, in some examples, at least one or more blocks are executed at least partially in parallel, in another order, or bypassed.

At block 602, an input signal (e.g., a current signal, a light or optical signal, etc.) can be provided to a plurality of sensors that are embedded in the structure and spaced apart along a filament. As the filament may be, for example, conductive or light transmitting (when implemented as an optical fiber), the filament embedded within the structure can permit the flow of the input signal. For example, with reference to FIG. 1A, the controller 110 may output an input signal to the filament 104. As another example, with reference to FIG. 1B, the controller 180 may output an input signal to the filament 154 or 158. As a further example, with reference to FIG. 2, a controller (not shown but, e.g., similar to the controller 110 or 180) may output an input signal to the filament 204 or 210.

At block 604, a controller (e.g., the controller 110 or 180) can receive an output signal (e.g., electronic signal, a light or optical signal, etc.) from the plurality of sensors via the filament. For example, with reference to FIG. 1A, the input signal provided to the filament 104 in block 602 may pass through the sensors 106 via the filament 104, and be received at an opposite end of the filament 104 by the controller 110 and/or at an end of one or more of the filament branches 105. As the input signal passes through the sensors 106, the sensors 106 may impact or modify the input signal (e.g., decrease current of an electronic signal by a varying amount, or vary polarization of a light or optical signal), where the impact or modification is dependent or based on the stress on the sensors 106 (and, thus, on the structure 100). The modified input signal may be received as the output signal by the controller 110. As another example, with reference to FIG. 1B, in block 604, the controller 180 may receive an output signal from the plurality of sensors 156 or 160 via the filament 154 or 158 (or a filament branch 155 or 159 thereof) in a similar manner as described with respect to the controller 110 and FIG. 1A. As another example, with reference to FIG. 2, in block 604, the controller may receive an output signal from the plurality of sensors 206 or 212 via the filament 204 or 210 (or filament branch thereof) in a similar manner as described with respect to the controller 110 and FIG. 1A.

Continuing, at block 606, a stress on the structure can be determined based on the output signal. For example, with reference to FIG. 1A, the controller 110 may determine the stress on the structure 100 based on the output signal. The output signal can be indicative of a capacitance of the filament 104 and the plurality of sensors 106, and the capacitance can indicate a stress level of the stress on the structure 100. In particular, when the structure 100 is under compressive stress, the filament may also be subject to compressive stress. Correspondingly, the filament may “slag” and bring sensor nodes of the plurality of sensors 106 closer to one another. Therefore, capacitance of the area under compression may increase and indicate a stress level of the stress on the structure 100. Similarly, when the structure 100 is under strain, the filament 104 and the plurality of sensors 106 may also be subject to strain. Correspondingly, the filament 104 may “stretch” and move sensor nodes of the plurality of sensors 106 further from one another. Therefore, capacitance of the area under strain may reduce and indicate a stress level of the stress on the structure 100. In some examples, the controller 110 may compute a stress level from the capacitance (e.g., using a predetermined formula defining a relationship therebetween) or may access a lookup table that maps capacitances to stress levels. In some examples, the controller 110 can supply a known current value at one end of the filament 104. Based on a current received at an opposite end of the filament 104 (or at a filament branch 105) (e.g., received as the electrical signal in block 604), the controller 110 may determine a resulting voltage across the plurality of sensors 106, and correspondingly, for example, a capacitance. In some examples, the controller 110 can supply a light or optical signal of a known polarization at one end of the filament 104. Based on a light or optical signal received at an opposite end of the filament 104 (or at a filament branch 105) (e.g., received as the signal in block 604), the controller 110 may determine a change in polarization of the light or optical signal, which may correspond to a particular amount of stress on the structure. For example, a pre-populated lookup table may map polarization changes to a particular amount of stress on the structure, where the table includes mappings based on experimental data and/or calculated data using equations for the particular sensors and/or structure.

Further, the output signal can be indicative of a facture of a particular sensor of the plurality of sensors that severs a conductive or optical path of the filament. In particular, when the filament is mechanically disconnected, the output signal may also be disconnected or interrupted and indicate the fracture. Thus, for example, the controller 110 may receive a signal via a first filament branch 105 and not from a second filament branch 105 because the fracture interrupts the signal output along the filament by the controller 110. Thus, the controller 110 may determine that a fracture occurred at the filament 104 between the two filament branches 105. Because the fracture point (stress level at which the sensor will fracture) of the sensors 106 may be known by the controller 110, the controller 110 can determine or infer that the structure 100 is under the stress level corresponding to the fracture point of the fractured sensor. Thus, the fracture can indicate a stress level of the stress on the structure 100. In some embodiments, the controller 110 can determine a location of the stress based on the output signal and a known location of the particular sensor that fractured. For example, the controller 110 may determine from the output signal (e.g., the electric signal) which sensor of the plurality of sensors 106 fractured. The controller 110 may then determine the location of the stress on the structure 100 based on stored location information for the sensor.

In some embodiments, upon a reduction of the stress after the fracture, the particular sensor may self-heal to reestablish the conductive path of the filament. In some cases, the self-healing capability of the sensor may enhance the longevity or reliability of the embedded sensor system, allowing for continuous monitoring even after temporary overload conditions. For example, when the stress is reduced, opposing sides of fracture point(s) of the particular sensor may rejoin (mend, fuse, reconnect, link, etc.) such that the particular sensor is no longer fractured and the conductive path of the filament is reestablished or resumed. In some embodiments, the sensor can include materials that enhance the self-healing mechanism, including self-healing polymers, reversible conductive gels, or liquid metal composites, etc. In some embodiments, the sensor design may incorporate magnetically reconnecting pathways, where magnetic particles embedded within the conductive elements are drawn together when stress is reduced, thereby restoring electrical conductivity. The self-healing functionality can enable the sensor system to automatically recover from fracture events without requiring manual intervention.

In some examples, in block 606, the controller 110 further determines temperature of the structure based on the output signal. For example, the conductivity or resistance of the filament 104 and plurality of sensors 106 may vary based on temperature. Thus, the current or voltage of the output signal received by the controller 110 may vary based on temperature. Accordingly, by measuring the current or voltage of the output signal, the controller 110 may determine conductivity (or resistance) of the filament 104 and sensors 106 (e.g., pre-fracture) and, thus, the temperature of the structure 100. Alternatively, the controller 110 can measure temperature of the structure 100 to assist in determining (e.g., calculate) a value of stress under compression or strain on the structure in some cases, because an amount of stress indicated by the output signal can vary based on temperature.

Although block 606 has been described primarily with respect to FIG. 1A, as another example, with reference to FIG. 1B, the controller 180 may determine a stress on the structure 150 based on the output signal received in block 604 in a similar manner as described with respect to the controller 110 and FIG. 1A. As another example, with reference to FIG. 2, in block 606, the controller (not shown) may determine a stress on the structure 200 based on the output signal received in block 604 in a similar manner as described with respect to the controller 110 and FIG. 1A.

At block 608, the stress on the structure can be indicated. For example, with reference to FIG. 1A, the controller 110 may output the stress on the structure 100 (determined in block 606) visually on a display of the I/O components 114, audibly via a speaker of the I/O components 114, and/or electronically via a transmission of the stress via the communications interface 118 to an external computing device. In some embodiments, to indicate the stress, the controller 110 generates a visual graph of the stress as a direct current waveform (e.g., for display or transmission), and the visual graph may indicate when an output signal is discontinued (e.g., at a filament fracture). As another example, with reference to FIG. 1B, the controller 180 may indicate the stress visually, audibly, and/or electronically in a similar manner as described with respect to the controller 110 of FIG. 1A. As another example, with reference to FIG. 2, the controller (not shown) may indicate the stress visually, audibly, and/or electronically in a similar manner as described with respect to the controller 110 of FIG. 1A.

In some examples, a controller (e.g., the controller 110, 180, or the controller (not shown) corresponding to the sensor system 202 of FIG. 2) may repeatedly execute the process 600 (e.g., loop back from block 608 to block 602) to continuously monitor the stress on the structure.

In some examples, a controller (e.g., the controller 110, 180, or the controller (not shown) corresponding to the sensor system 202 of FIG. 2) may receive multiple output signals (e.g., substantially simultaneously), each at a respective input or connection point (e.g., at each filament connection point and filament branch connection point to the controller 180). In such cases, the controller may execute the process 600 for each output signal to determine multiple stress levels, one for each output signal. The controller may then determine a stress on the structure based on these determined stress levels. For example, the controller may determine the stress on the structure as a mean or median of the determined stress levels, as a maximum of the determined stress level, or as a collection or array of multiple of the determined stress levels (e.g., where each value in the array represents a stress level from a particular sensor and, thus, of a particular location of the structure). The controller may then indicate the determined stress level.

In some examples, where a structure has multiple filaments and corresponding pluralities of sensors (e.g., as illustrated in FIG. 1B and 2), the controller (e.g., the controller 180 or the controller (not shown) corresponding to the sensor system 202 of FIG. 2) may execute the process 600 for each plurality of sensors, thus providing multiple indications of stress on the structure. As each plurality of sensors may comprise sensors of a particular type that have different characteristics relative to sensors of another plurality of sensors in the structure, the information provided by the sensors and determined by the controller may vary based on circumstances. For example, with reference to FIG. 1B, the first plurality of sensors 156 may have a fracture point that is lower than the fracture point of the second plurality of sensors 158. Accordingly, under a first level of stress, a sensor of the first plurality of sensors 156 may fracture, and may not be able to indicate higher levels of stress to the controller. However, the second plurality of sensors 160 may continue to indicate stress at the higher levels (at least until a sensor of the second plurality of sensors 160 fractures). Additionally, sensors may have higher precision or accuracy at certain temperatures or stress levels and, accordingly, the controller may indicate or select that a stress level determined based on an output signal from the first plurality of sensors 156 as the stress to indicate for the structure 150 and may ignore the stress level determined based on the output signal from the second plurality of sensors 160, or vice versa, depending on the circumstances.

Additionally, as an additional block of the process 600 (e.g., after block 608 or at another point) or separate from the process 600, the controller 180 may determine a stress level of the structure 150 based on the third plurality of sensors 168, which may be capacitive sensors as illustrated in FIG. 5. For example, the controller 180 may measure a capacitance each of the capacitive sensors of the sensors 168 via the plurality of conductors 162. As described above, the capacitance of each sensor of the sensors 168 may correspond to a stress of the structure at the location of the sensor. Accordingly, the controller 180 may determine a stress of the structure at each location of the sensors 168. The controller 180 may then indicate one or more of the stresses determined based on the sensors 168. The controller 180 may indicate the one or more of the stresses in a similar manner as described with respect to the stress indicated by controller 110 in some examples of the block 608 (e.g., output visually, output audibility, or transmit electronically).

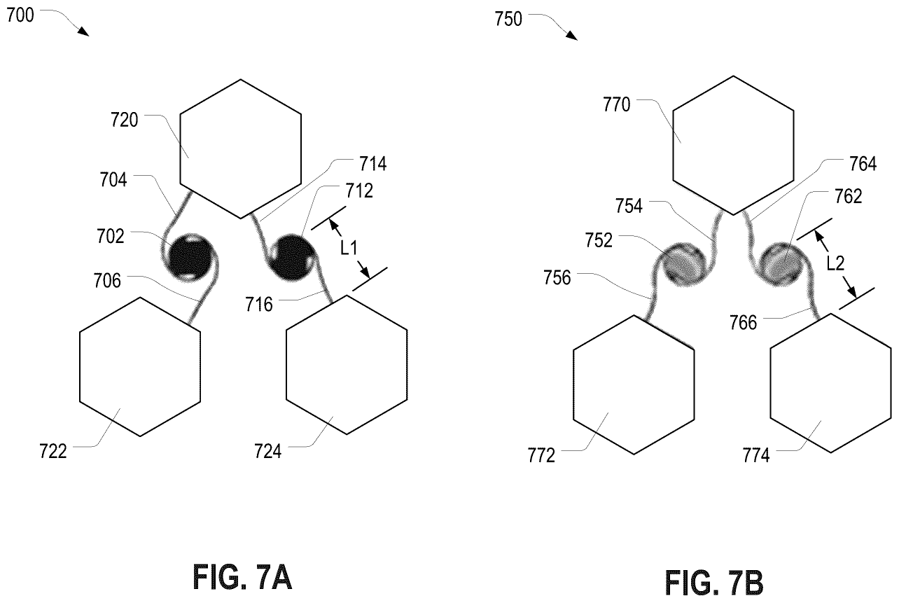

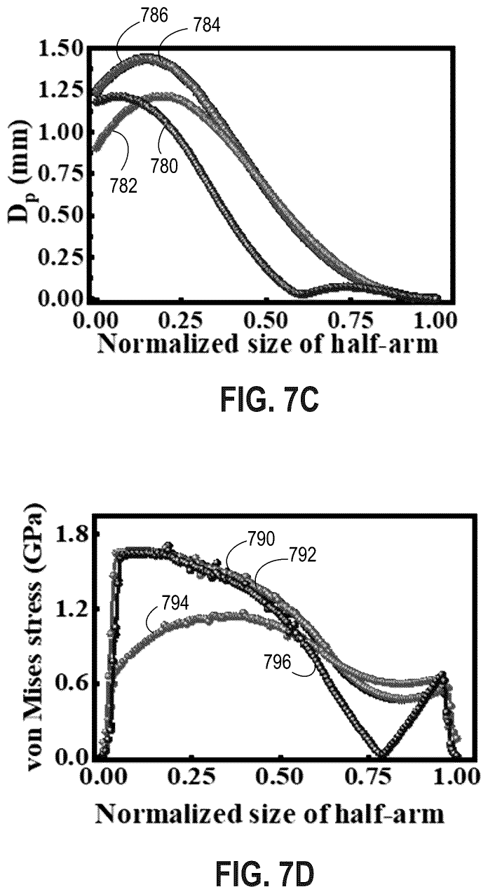

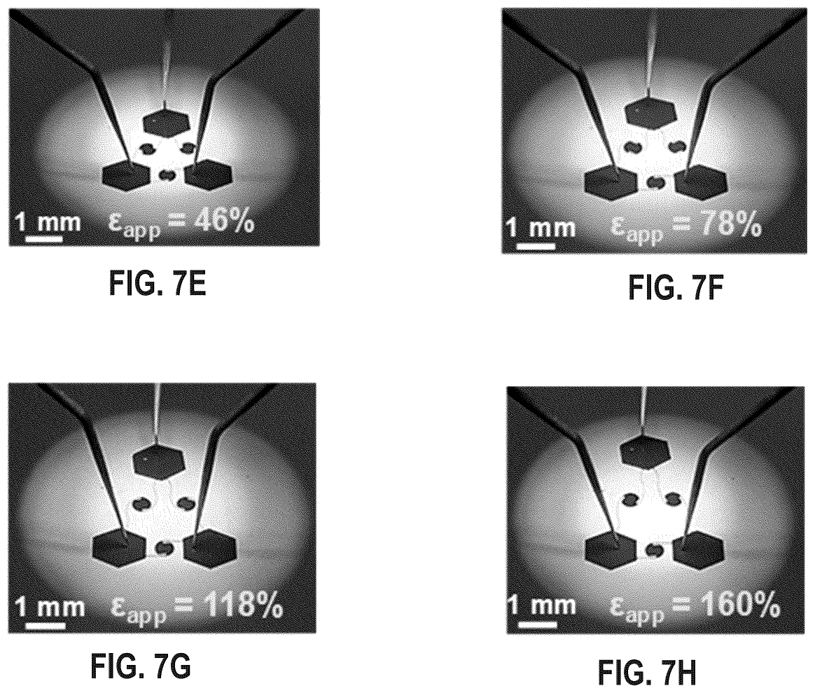

FIGS. 7A-7H illustrate examples of characteristics for a plurality of sensor sub-systems. In particular, FIG. 7A illustrates a sensor sub-system 700 that includes a plurality of sensor sub-systems similar to the first sensor sub-system 300 of FIG. 3 as discussed above. The sensor sub-system 700 includes a sensor 702 having one end connected by a spiral interconnect 704 to a conductive plate 720 and an opposite end connected by a spiral interconnect 706 to a conductive plate 722. The sensor sub-system 700 further includes a sensor 712 having one end connected by a spiral interconnect 714 to the conductive plate 720 (e.g., similar to the conductive plates 308, 310 of FIG. 3) and an opposite end connected by a spiral interconnect 716 to a conductive plate 724 (e.g., similar to the conductive plates 308, 310 of FIG. 3). Each of the spiral interconnects 704, 706, 714, 716 can include a length L1. In particular, the spiral interconnect 704 and the spiral interconnect 714 extend from the corresponding sensors 702, 712 in the same direction, along a left side of the sensors 702, 712 as shown in FIG. 7A. Further, the spiral interconnect 706 and the spiral interconnect 716 extend from the corresponding sensors 702, 712 in the same direction, along a right side of the sensors 702, 712 as shown in FIG. 7A. Accordingly, the sensor sub-system 700 can be described as to include a non-mirror configuration of the spiral interconnects. While the illustrated example does not show a sensor (e.g., a third sensor) connected to the conductive plate 722 and the conductive plate 724 via spiral interconnects, other examples can include a sensor between the conductive plates 722 and the conductive plate 724.

FIG. 7B illustrates a sensor sub-system 750 that includes a plurality of sensor sub-systems similar to the first sensor sub-system 300 of FIG. 3 as discussed above. The sensor sub-system 750 includes a sensor 752 having one end connected by a spiral interconnect 754 to a conductive plate 770 and an opposite end connected by a spiral interconnect 756 to a conductive plate 772. The sensor sub-system 750 further includes a sensor 762 having one end connected by a spiral interconnect 764 to the conductive plate 770 and an opposite end connected by a spiral interconnect 766 to a conductive plate 774. Each of the spiral interconnects 754, 756, 764, 766 can include a length L2. In particular, the spiral interconnect 754 and the spiral interconnect 764 extend from the corresponding sensors 752, 762 in opposite directions, along a right side of the sensor 752 and a left side of the sensor 762 as shown in FIG. 7B. Further, the spiral interconnect 756 and the spiral interconnect 766 extend from the corresponding sensors 752, 762 in opposite directions, along a left side of the sensor 752 and a right side of the sensor 762 as shown in FIG. 7B. Accordingly, the sensor sub-system 750 can be described as to include a mirror configuration of the spiral interconnects. While the illustrated example does not show a sensor connected to the conductive plate 772 and the conductive plate 774 via spiral interconnects, other examples can include the sensor between the conductive plates 772 and the conductive plate 774.

Referring to FIGS. 7C and 7D, deformation or displacement distribution along spiral interconnects, von Mises stress, and maximum elastic stretchability can be different based on an arrangement of conductive plates. FIG. 7C illustrates a graph showing deformation or displacement distribution along the arm of spiral interconnects plotted against the normalized size of half-arm (e.g., the length L1 of FIG. 7A or the length L2 of FIG. 7B). FIG. 7C shows comparative experimental data between the non-mirror configuration (e.g., the sensor sub-system 700) and the mirror configuration (e.g., the sensor sub-system 750). Curves 780 and 782 correspond to the spiral interconnects of the non-mirror configuration of FIG. 7A, and curves 784 and 786 correspond to the spiral interconnects of the mirror configuration of FIG. 7B. As shown by the lower two curves 780, 782 of the graph of FIG. 7C, the spiral interconnects 704, 706 showed different deformation distribution than the spiral interconnects 714, 716. As shown by the upper two curves 784, 786 of the graph of FIG. 7C, the spiral interconnects 754, 756 showed substantially similar (e.g., uniform) deformation distribution as the spiral interconnects 764, 766.

FIG. 7D illustrates a graph showing von Mises stress distribution plotted against normalized size of half-arm. In particular, the mirror configuration (e.g., as shown by upper two curves 790, 792 of FIG. 7D) exhibited more consistent stress distribution across both sets of spiral interconnects 754, 756 and 764, 766, while the non-mirror configuration showed varying stress levels with higher peak von Mises stress values (as shown by other curves 794, 796). As the conductive plate 720 was pulled away from the conductive plates 722, 724, the spiral interconnects 704, 706 unwrapped in a profile that is different than the spiral interconnects 714, 716. Correspondingly, the sensor sub-systems of the non-mirror configuration exhibited varying stress responses and deformation patterns under applied strain.

FIGS. 7E-7H illustrate the sensor sub-system of FIG. 7B in progressively elongated configurations. FIG. 7E shows the spiral interconnects under an applied strain (εₐₚₚ) of 46%, demonstrating the initial deformation behavior of the mirror configuration. FIG. 7F shows the spiral interconnects under an increased applied strain (εₐₚₚ) of 78%, demonstrating further unwrapping of the spiral structures while maintaining overall connectivity. FIG. 7G shows the spiral interconnects under a higher applied strain (εₐₚₚ) of 118%, demonstrating significant elongation and reconfiguration of the spiral structures. FIG. 7H shows the spiral interconnects under the maximum applied strain (εₐₚₚ) of 160%, demonstrating the extensive stretchability of the mirror configuration while maintaining electrical connectivity between the end points.

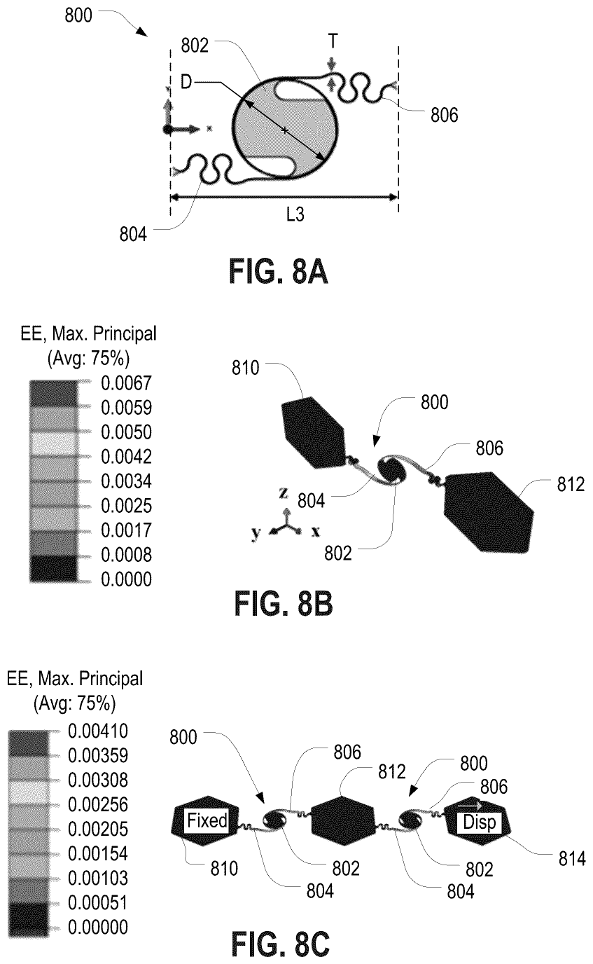

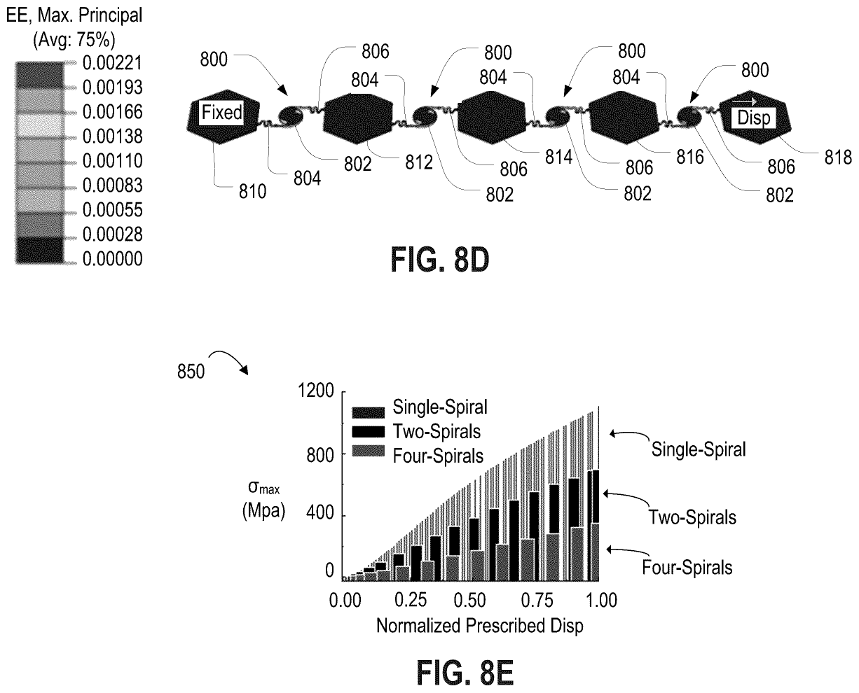

FIGS. 8A-8E illustrate examples of stress characteristics for a plurality of sensor sub-systems, which may be the first sensor sub-system 300, although other types of sensor sub-systems are possible. FIG. 8A shows a schematic of a sensor sub-system 800 that includes a sensor 802 having one end connected by a spiral interconnect 804 (e.g., to a conductive plate) and an opposite end connected by a spiral interconnect 806 (e.g., to a conductive plate). When the spiral interconnects 804, 806 are relaxed (e.g., unstretched by a displacement of the conductive plate), the sensor sub-system 800 includes a length L3 as measured between a distal end of the spiral interconnect 804, the sensor 802, and a distal end of the spiral interconnect 806 in an x-coordinate direction. In the illustrated example, the length L3 can be about 1114 μm. The sensor 802 includes a diameter D that is about 500 μm. Further, a thickness T of the spiral interconnect 804 or the spiral interconnect 806 is about 5 μm in the illustrated example. In other examples, other values for L3, D, and T may be used.

FIG. 8B illustrates a configuration with the sensor sub-system 800 connected between two conductive plates 810, 812 (e.g., similar to the conductive plates 308, 310 of FIG. 3). In the illustrated example, a maximum principal strain (εₘₐₓ) of the spiral interconnects 804, 806 was 0.67%. FIG. 8C shows a network of two sensor sub-systems 800 connected in series between the conductive plates 810, 812 and the conductive plates 812, 814, respectively. An elongation of each of the sensor sub-systems 800 is a half of a displacement of the conductive plate 814. In the illustrated example, εₘₐₓ of the spiral interconnects 804, 806 was 0.41%. FIG. 8D shows a network of four sensor sub-systems 800 connected in series between the conductive plates 810, 812, the conductive plates 812, 814, the conductive plates 814, 816, and the conductive plates 816 and 818, respectively. An elongation of each of the sensor sub-systems 800 is a quarter of the displacement of the conductive plate 814. In the illustrated example, εₘₐₓ of the spiral interconnects 804, 806 was 0.22%.

FIG. 8E illustrates a plot 850 that provides a comparison of maximum von Mises stress (σₘₐₓ) for these examples of FIGS. 8B-8C as a function of normalized prescribed displacement. The plot 850 demonstrates that von Mises stresses of multi-spiral configurations were less than a single-spiral configuration. For example, von Mises stress of the two-spiral configuration (e.g., the network of two sensor sub-systems 800 of FIG. 8C) and the four-spiral configuration (e.g., the network of four sensor sub-systems 800 of FIG. 8D) were each less than the single-spiral configuration (e.g., the sensor sub-system 800 of FIG. 8B). In particular, the four-spiral configuration exhibited the lowest amount of maximum von Mises stress compared to the two-spiral configuration or the single-spiral configuration. The stress-strain relationship remained linearly proportional. Thus, in some cases, the series configurations of sensor sub-systems can enable customization of mechanical response of the sensor system based on application requirements.

### EXAMPLES

Example 1: A method, apparatus, and/or non-transitory computer-readable medium storing processor-executable instructions for an embedded sensor system comprising: a filament embedded within a structure; a plurality of sensors spaced apart along the filament and in communication with the filament; and a controller including an electronic processor, the controller configured to: provide an input signal (e.g., current), via the filament, to the plurality of sensors; receive an output signal (e.g., electronic signal) from the plurality of sensors via the filament; determine a stress on the structure based on the electronic signal; and indicate the stress on the structure.

Example 2: The method, apparatus, and/or non-transitory computer-readable medium of Example 1, further comprising: a second filament embedded within the structure; and a second plurality of sensors spaced apart along the second filament and in communication with the second filament, wherein the controller is further configured to: provide a second input signal (e.g., current), via the second filament, to the second plurality of sensors; receive a second output signal (e.g., electronic signal or electric signal) from the second plurality of sensors via the second filament; determine a second stress on the structure based on the second output signal; and indicate the second stress on the structure.

Example 3: The method, apparatus, and/or non-transitory computer-readable medium of Example 1 or 2, wherein the plurality of sensors is of a first type, and the second plurality of sensors are of a second type that is different than the first type.

Example 4: The method, apparatus, and/or non-transitory computer-readable medium of any of Examples 1 to 3, wherein the plurality of sensors have at least one selected from a group of: a different sensitivity to stress than the second plurality of sensors, a different fracture point than the second plurality of sensors, a different prescribed displacement than the second plurality of sensors, or a different maximum stretchability than the second plurality of sensors.

Example 5: The method, apparatus, and/or non-transitory computer-readable medium of any of Examples 1 to 4, wherein the plurality of sensors and the filament extend along a first axis of the structure and wherein the second plurality of sensors and the second filament extend along a second axis of the structure that is substantially parallel to the first axis.

Example 6: The method, apparatus, and/or non-transitory computer-readable medium of any of Examples 1 to 5, wherein the controller is further configured to determine a temperature of the structure based on a conductivity of the plurality of sensors indicated by the output signal.

Example 7: The method, apparatus, and/or non-transitory computer-readable medium of any of Examples 1 to 6, where the plurality of sensors is positioned within cavities of the structure that were formed during an additive manufacturing process used to make the structure.

Example 8: The method, apparatus, and/or non-transitory computer-readable medium of any of Examples 1 to 7, wherein the output signal is indicative of a capacitance of the filament and the plurality of sensors, and the capacitance indicates a stress level of the stress.

Example 9: The method, apparatus, and/or non-transitory computer-readable medium of any of Examples 1 to 8, wherein the output signal is indicative of a fracture of a particular sensor of the plurality of sensors that severs a conductive path of the filament, wherein the fracture indicates a stress level of the stress, and wherein the controller is further configured to determine a location of the stress based on the output signal and a known location of the particular sensor.

Example 10: The method, apparatus, and/or non-transitory computer-readable medium of Example 9, wherein the output signal is indicative of the fracture of the particular sensor, and wherein, upon a reduction of the stress after the fracture, the particular sensor is configured to self-heal to reestablish the conductive path of the filament.

Example 11: The method, apparatus, and/or non-transitory computer-readable medium of any of Examples 1 to 10, wherein the filament comprises filament segments and the plurality of sensors are connected in series along the filament, with a filament segment of the filament segments between adjacent sensors of the plurality of sensors.

Example 12: The method, apparatus, and/or non-transitory computer-readable medium of any of Examples 1 to 11, wherein the plurality of sensors includes a serpentine sensor comprising a first sub-sensor connected by a serpentine interconnect to a second sub-sensor, the serpentine interconnect including a plurality of curved portions.

Example 13: The method, apparatus, and/or non-transitory computer-readable medium of Example 12, wherein the serpentine sensor has a first capacitance when the serpentine interconnect is in an extended configuration and a second capacitance when the serpentine interconnect is in a retracted configuration, the second capacitance being greater than the first capacitance.

Example 14: The method, apparatus, and/or non-transitory computer-readable medium of any of Examples 1 to 13, wherein the plurality of sensors includes a spiral sensor comprising a sensor having one end connected by a first spiral interconnect to a first conductive plate and an opposite end connected by a second spiral interconnect to a second conductive plate.

Example 15: The method, apparatus, and/or non-transitory computer-readable medium of Example 14, wherein the spiral sensor has a first capacitance when the spiral sensor is in an extended configuration and a second capacitance when the spiral sensor is in a retracted configuration, the first and second conductive plates being at a greater distance apart in the extended configuration than in the retracted configuration.

Example 16: The method, apparatus, and/or non-transitory computer-readable medium of any of Examples 1 to 15, wherein the plurality of sensors includes a flexible substrate.

Example 17: The method, apparatus, and/or non-transitory computer-readable medium of any of Examples 1 to 16, further comprising: a plurality of capacitive sensors embedded in the structure and in communication with the controller, wherein each capacitive sensor of the plurality of capacitive sensors has a capacitance that varies based on an amount of stress on the structure.

Example 18: The method, apparatus, and/or non-transitory computer-readable medium of any of Examples 1 to 17, wherein each capacitive sensor includes two conductive elements spaced apart from one another, where stress on the structure changes a distance that the two conductive elements are spaced apart from one another, thereby changing the capacitance of the capacitive sensor.

Example 19: The method, apparatus, and/or non-transitory computer-readable medium of any of Examples 1 to 18, wherein the structure is stainless steel beam.

Example 20: The method, apparatus, and/or non-transitory computer-readable medium of any of Examples 1 to 19, wherein the filament comprises a plurality of filament branches, and wherein the controller is configured to receive the output signal via the filament by receiving the output signal via at least one of the plurality of the filament branches.

Example 21: A method, apparatus, and/or non-transitory computer-readable medium storing processor-executable instructions for an embedded sensor system comprising: a filament embedded within a structure and configured to receive an input signal, the filament including filament segments; and a plurality of sensors spaced apart along the filament in series and in communication with the filament, adjacent sensors of the plurality of sensors including a filament segment of the filament segments therein between, the plurality of sensors configured to provide an output signal via the filament indicative of a stress on the structure.

Example 22: The method, apparatus, and/or non-transitory computer-readable medium of Example 21, wherein the plurality of sensors includes one or more of: a serpentine sensor comprising a first sub-sensor connected by a serpentine interconnect to a second sub-sensor, the serpentine interconnect including a plurality of curved portions; or a spiral sensor comprising a sensor having one end connected by a first spiral interconnect to a first conductive plate and an opposite end connected by a second spiral interconnect to a second conductive plate.

Example 23: The method, apparatus, and/or non-transitory computer-readable medium of Example 21, wherein the plurality of sensors includes a capacitive sensor that includes a capacitance that varies based on an amount of stress on the structure.

Example 24: The method, apparatus, and/or non-transitory computer-readable medium of any of Examples 21 to 23, further comprising: a second filament embedded within the structure configured to receive a second input signal; and a second plurality of sensors spaced apart along the second filament, in communication with the second filament, and configured to provide a second output signal via the second filament indicative of a second stress on the structure.

Example 25: The method, apparatus, and/or non-transitory computer-readable medium of any of Examples 21 to 24, wherein the plurality of sensors is of a first type, and the second plurality of sensors are of a second type that is different than the first type.

Example 26: The method, apparatus, and/or non-transitory computer-readable medium of any of Examples 21 to 25, wherein the plurality of sensors have at least one selected from a group of: a different sensitivity to stress than the second plurality of sensors, a different fracture point than the second plurality of sensors, a different prescribed displacement than the second plurality of sensors, or a different maximum stretchability than the second plurality of sensors.

Example 27: The method, apparatus, and/or non-transitory computer-readable medium of any of Examples 21 to 26, wherein the plurality of sensors and the filament extend along a first axis of the structure and wherein the second plurality of sensors and the second filament extend along a second axis of the structure that is substantially parallel to the first axis.

Example 28: The method, apparatus, and/or non-transitory computer-readable medium of any of Examples 21 to 27, where the plurality of sensors is positioned within cavities of the structure that were formed during an additive manufacturing process used to make the structure.

Example 29: The method, apparatus, and/or non-transitory computer-readable medium of any of Examples 21 to 28, wherein the output signal is indicative of a capacitance of the filament and the plurality of sensors, and the capacitance indicates a stress level of the stress.

Example 30: The method, apparatus, and/or non-transitory computer-readable medium of any of Examples 21 to 28, wherein the output signal is indicative of a fracture of a particular sensor of the plurality of sensors that severs a conductive path of the filament, wherein the fracture indicates a stress level of the stress.

Example 31: The method, apparatus, and/or non-transitory computer-readable medium of Example 30, wherein the output signal is indicative of the fracture of the particular sensor, and wherein, upon a reduction of the stress after the fracture, the particular sensor is configured to self-heal to reestablish the conductive path of the filament.

Example 32: The method, apparatus, and/or non-transitory computer-readable medium of any of Examples 21 to 31, wherein the plurality of sensors includes a serpentine sensor comprising a first sub-sensor connected by a serpentine interconnect to a second sub-sensor, the serpentine interconnect including a plurality of curved portions.

Example 33: The method, apparatus, and/or non-transitory computer-readable medium of Example 32, wherein the serpentine sensor has a first capacitance when the serpentine interconnect is in an extended configuration and a second capacitance when the serpentine interconnect is in a retracted configuration, the second capacitance being greater than the first capacitance.

Example 34: The method, apparatus, and/or non-transitory computer-readable medium of any of Examples 21 to 33, wherein the plurality of sensors includes a spiral sensor comprising a sensor having one end connected by a first spiral interconnect to a first conductive plate and an opposite end connected by a second spiral interconnect to a second conductive plate.

Example 35: The method, apparatus, and/or non-transitory computer-readable medium of Example 34, wherein the spiral sensor has a first capacitance when the spiral sensor is in an extended configuration and a second capacitance when the spiral sensor is in a retracted configuration, the first and second conductive plates being at a greater distance apart in the extended configuration than in the retracted configuration.

Example 36: The method, apparatus, and/or non-transitory computer-readable medium of any of Examples 21 to 35, wherein the plurality of sensors includes a flexible substrate.

Example 37: The method, apparatus, and/or non-transitory computer-readable medium of any of Examples 21 to 36, further comprising: a plurality of capacitive sensors embedded in the structure and in communication with the controller, wherein each capacitive sensor of the plurality of capacitive sensors has a capacitance that varies based on an amount of stress on the structure.

Example 38: The method, apparatus, and/or non-transitory computer-readable medium of any of Examples 21 to 37, wherein each capacitive sensor includes two conductive elements spaced apart from one another, where stress on the structure changes a distance that the two conductive elements are spaced apart from one another, thereby changing the capacitance of the capacitive sensor.

Example 39: The method, apparatus, and/or non-transitory computer-readable medium of any of Examples 21 to 38, wherein the structure is stainless steel beam.

Example 40: The method, apparatus, and/or non-transitory computer-readable medium of any of Examples 21 to 39, wherein the filament comprises a plurality of filament branches, and at least one of the plurality of the filament branches is configured to provide the output signal.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. An embedded sensor system, comprising:
a filament embedded within a structure;
a plurality of sensors spaced apart along the filament and in communication with the filament; and
a controller including an electronic processor, the controller configured to:
provide input signal, via the filament, to the plurality of sensors;
receive an output signal from the plurality of sensors via the filament;
determine a stress on the structure based on the output signal; and
indicate the stress on the structure.

2. The embedded sensor system of claim 1, further comprising:
a second filament embedded within the structure; and
a second plurality of sensors spaced apart along the second filament and in communication with the second filament,
wherein the controller is further configured to:
provide a second input signal, via the second filament, to the second plurality of sensors;
receive a second output signal from the second plurality of sensors via the second filament;
determine a second stress on the structure based on the second output signal; and
indicate the second stress on the structure.

3. The embedded sensor system of claim 2, wherein the plurality of sensors includes sensors of a first type and the second plurality of sensors includes sensors of a second type that is different than the first type.

4. The embedded sensor system of claim 2, wherein the plurality of sensors has at least one selected from a group of:
a different sensitivity to stress than the second plurality of sensors,
a different fracture point than the second plurality of sensors,
a different prescribed displacement than the second plurality of sensors, or
a different maximum stretchability than the second plurality of sensors.

5. The embedded sensor system of claim 2, wherein the plurality of sensors and the filament extend along a first axis of the structure and wherein the second plurality of sensors and the second filament extend along a second axis of the structure that is substantially parallel to the first axis.

6. The embedded sensor system of claim 1, where the plurality of sensors is positioned within cavities of the structure that were formed during an additive manufacturing process used to make the structure.

7. The embedded sensor system of claim 1, wherein the plurality of sensors includes a serpentine sensor comprising a first sub-sensor connected by a serpentine interconnect to a second sub-sensor, the serpentine interconnect including a plurality of curved portions.

8. The embedded sensor system of claim 7, wherein the serpentine sensor has a first capacitance when the serpentine interconnect is in an extended configuration and a second capacitance when the serpentine interconnect is in a retracted configuration, the second capacitance being greater than the first capacitance.

9. The embedded sensor system of claim 1, wherein the plurality of sensors includes a spiral sensor comprising a sensor having one end connected by a first spiral interconnect to a first conductive plate and an opposite end connected by a second spiral interconnect to a second conductive plate.

10. The embedded sensor system of claim 9, wherein the spiral sensor has a first capacitance when the spiral sensor is in an extended configuration and a second capacitance when the spiral sensor is in a retracted configuration, the first and second conductive plates being at a greater distance apart in the extended configuration than in the retracted configuration.

11. The embedded sensor system of claim 1, further comprising:
a plurality of capacitive sensors embedded in the structure and in communication with the controller, wherein each capacitive sensor of the plurality of capacitive sensors has a capacitance that varies based on an amount of stress on the structure.

12. The embedded sensor system of claim 11, wherein each capacitive sensor includes two conductive elements spaced apart from one another, where stress on the structure changes a distance that the two conductive elements are spaced apart from one another, thereby changing the capacitance of the capacitive sensor.

13. The embedded sensor system of claim 1, wherein the filament comprises a plurality of filament branches, and wherein the controller is configured to receive the output signal via the filament by receiving the output signal via at least one of the plurality of the filament branches.

14. A method for monitoring stress on a structure, the method comprising:
providing an input signal, via a filament embedded within the structure, to a plurality of sensors embedded in the structure and spaced apart along the filament;
receiving, by a controller, an output signal from the plurality of sensors via the filament;
determining a stress on the structure based on the output signal; and
indicating the stress on the structure.

15. The method of claim 14, further comprising determining a temperature of the structure based on a conductivity of the plurality of sensors indicated by the output signal.

16. The method of claim 14, wherein the output signal is indicative of one or more of:
a capacitance of the filament and the plurality of sensors, and the capacitance indicates a stress level of the stress; or
a fracture of a particular sensor of the plurality of sensors that severs a conductive path of the filament, wherein the fracture indicates a stress level of the stress, and wherein the controller is further configured to determine a location of the stress based on the output signal and a known location of the particular sensor.

17. The method of claim 16, wherein the output signal is indicative of the fracture of the particular sensor, and wherein the method further comprises:
upon a reduction of the stress after the fracture, the particular sensor is configured to self-heal to reestablish the conductive path of the filament.

18. An embedded sensor system, comprising:
a filament embedded within a structure and configured to receive an input signal, the filament including filament segments; and
a plurality of sensors spaced apart along the filament in series and in communication with the filament, adjacent sensors of the plurality of sensors including a filament segment of the filament segments therein between, the plurality of sensors configured to provide an output signal via the filament indicative of a stress on the structure.

19. The embedded sensor system of claim 18, wherein the plurality of sensors includes one or more of:
a serpentine sensor comprising a first sub-sensor connected by a serpentine interconnect to a second sub-sensor, the serpentine interconnect including a plurality of curved portions; or
a spiral sensor comprising a sensor having one end connected by a first spiral interconnect to a first conductive plate and an opposite end connected by a second spiral interconnect to a second conductive plate.

20. The embedded sensor system of claim 18, wherein the plurality of sensors includes a capacitive sensor that includes a capacitance that varies based on an amount of stress on the structure.
